(19) United States
(12) Patent Application Publication
(10) Pub. No.: US 2020/0311574 A1
(43) Pub. Date: Oct. 1, 2020

(54) REGRESSION APPARATUS, REGRESSION METHOD, AND COMPUTER-READABLE STORAGE MEDIUM

(71) Applicant: NEC CORPORATION, Tokyo (JP)

(72) Inventor: Daniel Georg ANDRADE SILVA, Tokyo (JP)

(73) Assignee: NEC CORPORATION, Tokyo (JP)

(21) Appl. No.: 16/651,203

(22) PCT Filed: Sep. 29, 2017
(86) PCT No.: PCT/JP2017/035745

§ 371 Date: Mar. 26, 2020

(51) Int. Cl. G06N 5/04; G06N 20/00

(52) U.S. Cl. CPC G06N 5/04; G06N 20/00

(57) ABSTRACT

A regression apparatus 10 that optimizes a joint regression and clustering criteria includes a train classifier unit and an acquire clustering result unit. The train classifier unit trains a classifier with a weight vector or a weight matrix, using labeled training data, a similarity of features, a loss function characterizing regression quality, and a penalty encouraging the similarity of features, wherein a strength of the penalty is proportional to the similarity of features. The acquire clustering result unit an acquire clustering result unit that, using the trained classifier, to identify feature clusters by grouping the features which regression weight is equal.

### TECHNICAL FIELD

The present invention relates to a regression apparatus, and a regression method for learning a classifier and cluster the covariates (features of each data sample), and a computer-readable storage medium storing a program fix realizing these.

### BACKGROUND ART

Classification and interpretability of the classification result is important fix various applications. For example: Text classification: which groups of words are indicative of the sentiment? Microarray classification: which groups of genes are indicative of a certain disease?

In particular, we consider here the problem where the following information is available:

Data samples with class labels,

Prior knowledge about the interaction of the features (e.g. word similarity).

There is only few prior works that addresses this problem. The first work, called OSCAR (e.g., see NPL 1), performs joint linear regression and clustering using the following objective function. The objective function is a also convex problem (like one of our proposed methods). However, it has mainly two problems/limitations:

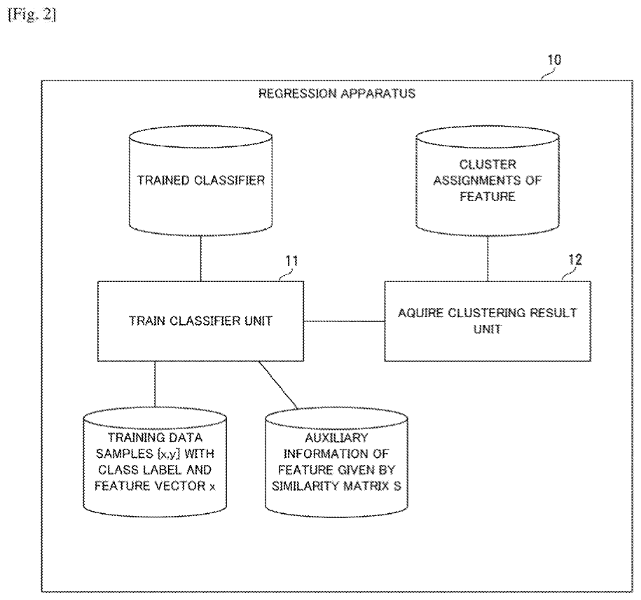

Highly negative correlated covariates are also put into the same cluster. This is not a problem for the predictive power (since the absolute values are encouraged to be the same, and not the original value), however interoperability may suffer (see Remark to FIG. 2 in NPL 1).

Auxiliary information about the features (covariates) cannot not be included.

Another approach that allows to include auxiliary information about covariates is BOWL (e.g., see NPL 2). The basic components are illustrated in FIG. 7. FIG. 7 shows that clustering before classification can lead to clusters that are not adequate for classification.

It is a two-step approach that

1. Cluster covariates e.g. with k-means. Here they cluster words using word embeddings.

2. Train a classifier with the word clusters.

### CITATION LIST

### Non Patent Literature

NP1: Howard D Bondell and Brian J Reich. Simultaneous regression shrink-age, variable selection, and supervised clustering of predictors with oscar. Biometrics, 64(1): 115-123, 2008.

NPL 2: Weikang Rui, Kai Xing, and Yawei Jia. Bowl: Bag of word clusters text representation using word embeddings. In International Conference on Knowledge Science, Engineering and Management, pages 3-14. Springer, 2016.

### SUMMARY OF INVENTION

### Technical Problem

However, the main problem is that the clustering (after first step) is fixed and can got adjust to the class labels. To see why this is a problem, consider the following example.

Let us assume that the word embeddings of “great” and “bad” are very similar (which indeed is often the case, since they can occur in very similar contexts). This would lead to the result that in the first step, “great” and “bad” are clustered together.

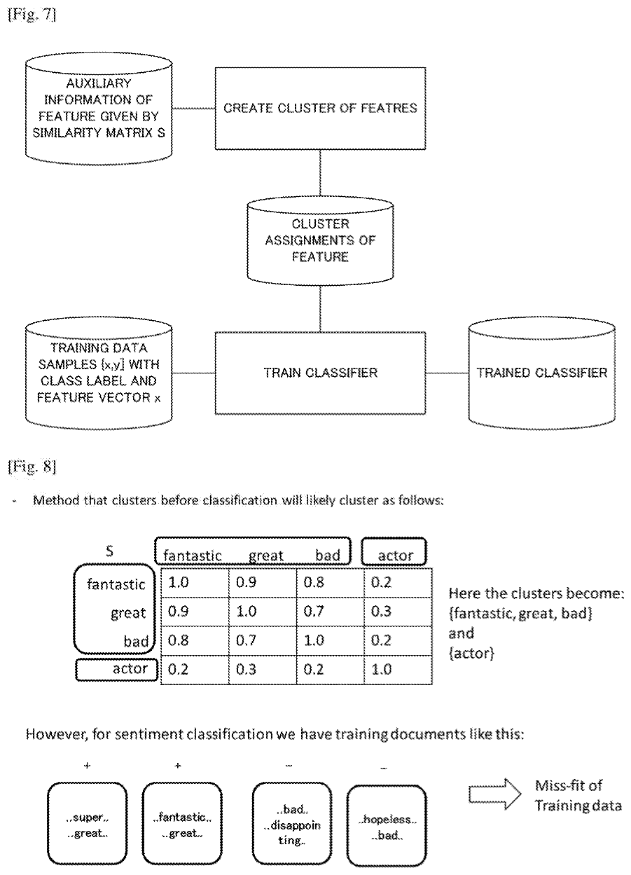

However, if the classification task is sentiment classification, then this will degrade performance, (Reason: the cluster (“great”, “bad”) will be a feature that cannot be used for distinguishing positive and negative comments). This example, is also illustrated in FIG. 8 where the final result consists of two clusters (“fantastic”, “great”, “bad”) and (“actor”). FIG. 8 shows that clustering before classification can lead to clusters that are not adequate for classification.

Previous methods can either not include prior knowledge about covariates, or they suffer from degraded solutions which are due to a sub-optimal two step procedure (see above example), and are prone to bad local minima due to a non-convex optimization function.

One example of an object of the present invention is to provide a regression apparatus, a regression method, and a computer-readable storage medium according to which the above-described problems are eliminated and a quality of the resulting classification and clustering are both improved.

### Solution to Problem

Instead of separating the clustering and classification step, we propose a apparatus, a method, and a computer-readable storage medium that jointly learns the parameters of a classier and a clustering of the covariates. Furthermore, we propose a solution that is convex, and, therefore independent of the initialization is guaranteed to find the global optima.

In order to achieve the foregoing object, a regression apparatus according to one aspect of the present invention is for optimizing a joint regression and clustering criteria, and includes:

a train classifier unit that trains a classifier with a weight vector or a weight matrix, using labeled training data, a similarity of features, a loss function characterizing regression quality, and a penalty encouraging the similarity of features, wherein the strength of the penalty is proportional to the similarity of features.

an acquire clustering result unit that, uses the trained classifier, to identify feature clusters by grouping the features which regression weights are equal.

In order to achieve the foregoing object, a regression method according to another aspect of the present invention is for optimizing a joint regression and clustering criteria, and includes:

(a) a step of training a classifier with a weight vector or a weight matrix, using labeled training data, a similarity of features, a loss function characterizing regression quality, and a penalty encouraging the similarity of features, wherein the strength of the penalty is proportional to the similarity of features,

(b) a step of, by using the trained classifier, identifying feature dusters by grouping the features which regression weights are equal.

In order to achieve the foregoing object, a computer-readable recording medium according to still another aspect of the present invention has recorded therein a program for optimizing a joint regression and clustering criteria using a computer, and the program includes an instruction to cause the computer to execute:

(a) a step of training a classifier with a weight vector or a weight matrix, using labeled training data, a similarity of features, a loss function characterizing regression quality, and a penalty encouraging the similarity of features, wherein the strength of the penalty is proportional to the similarity of features,

(b) a step of, by using the trained classifier, identifying feature clusters by grouping the features which regression weights are equal.

### Advantageous Effects of Invention

As described above, the present invention can improve a quality of the resulting classification and clustering.

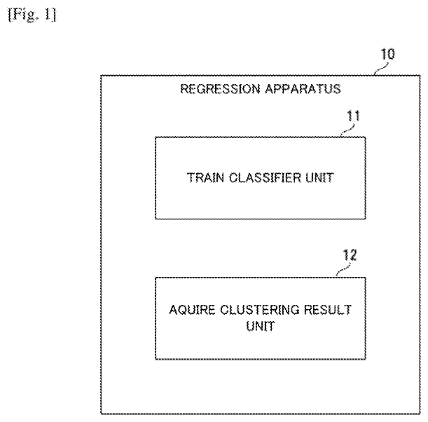

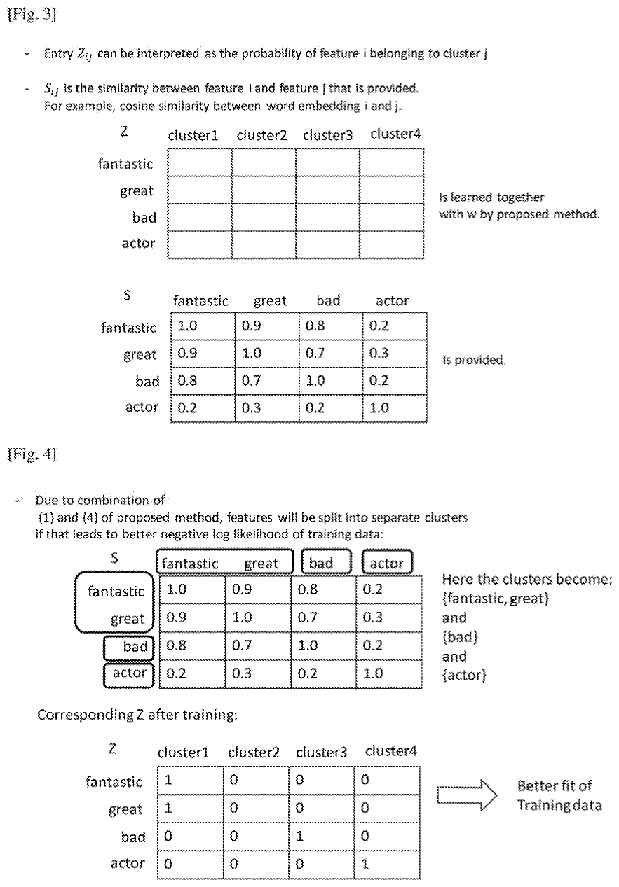

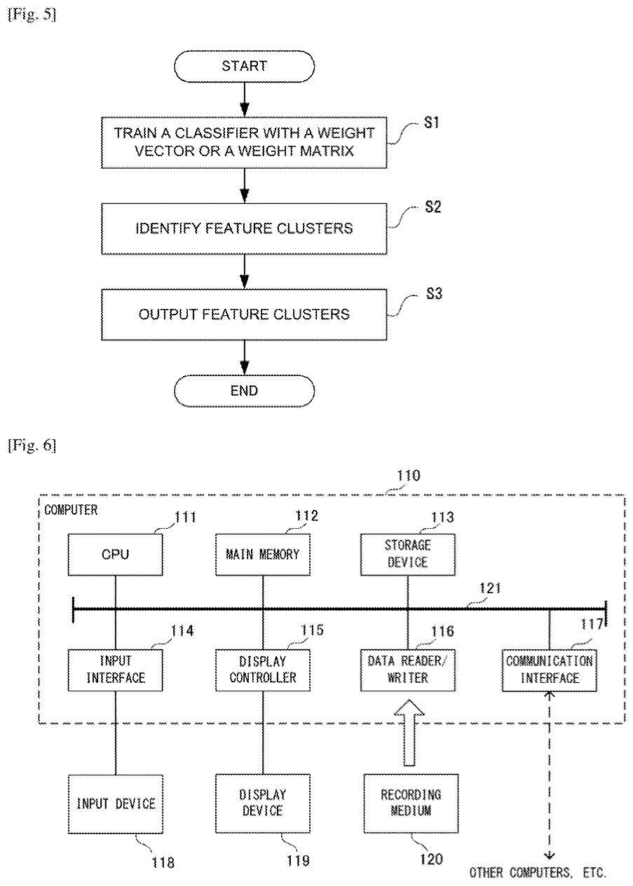

### BRIEF DESCRIPTION OF DRAWINGS

[FIG. 1]FIG. 1 is a block diagram schematically showing the configuration of the regression apparatus according to the embodiment of the present invention.

[FIG. 2]FIG. 2 is a block diagram specifically showing the configuration of the regression apparatus according to the embodiment of the present invention.

[FIG. 3]FIG. 3 gives an example of the matrix Z used by the present invention.

[FIG. 4]FIG. 4 gives an example of the clustering result acquired by the present invention.

[FIG. 5]FIG. 5 is a flow diagram showing an example of operations performed by a regression apparatus according to an embodiment of the present invention.

[FIG. 6]FIG. 6 is a block diagram showing an example of a computer that realizes the monitoring apparatus according to an embodiment of the present invention.

[FIG. 7]FIG. 7 shows that clustering before classification can lead to clusters that are not adequate for classification.

[FIG. 8]FIG. 8 shows that clustering before classification can lead to clusters that are not adequate for classification.

### DESCRIPTION OF EMBODIMENTS

### Embodiment

The following describes a regression apparatus, a regression method, and a computer-readable recording medium according to an embodiment of the present invention with reference to FIGS. 1 to 6.

### Device Configuration

First, a configuration of a regression apparatus 10 according to the present embodiment will be described using FIG. 1. FIG. is a block diagram schematically showing the configuration of the regression apparatus according to the embodiment of the present invention.

As shown in FIG. 1, the regression apparatus 10 includes a train classifier unit 11 and an acquire clustering result unit. The train classifier unit is configured to train a classifier with a weight vector or a weight matrix, using labeled training data, a similarity of features, a loss function characterizing regression quality, and a penalty encouraging the similarity of features. The strength of the penalty is proportional to the similarity of features. The acquire clustering result unit is configured to, using the trained classifier, identify feature clusters by grouping the features which regression weight is equal.

As described above, the regression apparatus 10 learns the parameters of a classier and a clustering of the covariates. As a result, the regression apparatus 10 can improve a quality of the resulting classification and clustering.

Here, a configuration and function of a regression apparatus 10 according to the present embodiment 1 will also be described in addition to the monitoring apparatus 10 with reference to FIG. 2.

Remark about our notation: We denote a matrix, e.g. B εR^{d×d}, and a column vector e.g. x ε R^{d}. Furthermore, the i-th row of B is denoted by B [symbol] , and is a row vector. The j-th column of B is denoted by B [symbol] and is a column vector.

Our proposed procedure is outlined in the diagram shown in FIG. 2. FIG. 2 is a block diagram specifically showing the configuration of the regression apparatus according to the embodiment of the present invention.

As shown in FIG. 2, using labeled training data (given by {x, y}) and the similarity information between each feature (given by matrix S), the train classifier unit 10 trains a logistic regression classifier with a weight vector β or a weight matrix B. In the next step, the acquire clustering result unit 20, from the learned weight matrix B (or weight vector β), can identify the clustering of the features by inspecting the value that are exactly equal. For example, if the i₁'s and i₂'s columns of weight matrix B are identical, then the features i₁ and i₂ are in the same cluster.

In the following, we propose two different formulations as an optimization problem. The general idea is to jointly cluster the features (covariates) and learn a classifier.

The first formulation provides explicit cluster assignment probabilities for each covariate. This can be advantageous for example, when the meaning of covariates is ambiguous. However, the resulting problem is not convex. The second formulation is convex, and we therefore can find a global optima.

### Formulation 1: A Cluster Assignment Probability Formulation

In the formulation 1, the loss function is the multi-logistic regression loss with regression weight vectors for each feature, and includes a penalty. The penalty is set for each pair of features, and consists of some distance measure between each pair of feature weight vector times the similarity between the features.

Let xₛ ε R^{d} denote the covariate vector of sample s, and Let Z ε R^{d×d} be the covariate-cluster assignment matrix, where the i-th row corresponds to the i-th covariate, and the j-th column corresponds to the j-th cluster.

For simplicity, we consider here logistic regression for classification. Let f be the logistic function with parameter vector β ε R^{d} and bias β₀. Class probability is defined as follows.

$$f ( {y}_{s} \vert {x}_{s} , β , {β}_{0} ) = \frac{1}{1 + exp ( - {y}_{s} \cdot ( {β}^{T} {x}_{s} + {β}_{0} ) )} . \qquad [ Math .1 ]$$

yₛ ε {−1, 1} is the class-label of samples. Then our objective time ion is optimized by the following equation.

$$\begin{matrix}minimize - {\sum }_{s = 1}^{n} log f ( {y}_{s} \vert {x}_{s} , β , {β}_{0} ) + λ {\sum }_{j = 1}^{d} {‖ Z {.}_{, j} ‖}_{2} + γ {‖ w ‖}_{2}^{2} & [ Math .2 ] \\ subject to β = Zw , & [ Math .3 ] \\ ∀ i , j ∈ \{ 1 , … , d \} \text{:} {Z}_{ij} \geq 0 , & [ Math .4 ] \\ ∀ i ∈ \{ 1 , … , d \} \text{:} {\sum }_{j} {Z}_{ij} = 1. & [ Math .5 ]\end{matrix}$$

The parameters β, w εRd, β0εR and ZεRd×d, and fixed hyper-parameters λ>0 and γ>=0. λ is a hyper-parameter that controls the sparsity of the columns of Z, and therefore the number of clusters. To understand this, note that the term A(Math. 6) is a group lasso penalty on the columns of Z (for group lasso see e.g. reference [1]). The hyper-parameter γ controls the weight of the clustering objective.

Reference [1]: Trevor Hastie, Robert Tibshirani, and Martin Wainwright. Statistical learning with sparsity. CRC press, 2015.

$$A = λ {\sum }_{j = 1}^{d} {‖ Z . {,}_{j} ‖}_{2} \qquad [ Math . 6 ]$$

The matrix Z dotes the clustering. To better understand the resulting clustering, note that in Equation (1), we can write as follows.

$$\begin{matrix}{β}^{T} {x}_{s} = {w}^{T} {c}_{s} . & [ Math . 7 ] \\ {c}_{s} := {Z}^{T} {x}_{s} . & [ Math . 8 ]\end{matrix}$$

The vector cₛ represents data sample s in terms of the clustering induced by Z. In particular, we have the following,

$${c}_{s} ( j ) = \{ \begin{matrix}0 , & if cluster j does not exist , \\ {\sum }_{i} {x}_{s} ( i ) {Z}_{i , j} , & if cluster j exists .\end{matrix} \qquad [ Math .9 ]$$

We say a cluster j exists, if and only if, the j-th column Z is not the zero vector. Therefore, we see that the number of clusters is controlled by the hyper-parameter λ, since it controls the number of zero columns in Z. We also see that Z_{i,j} can be interpreted as the probability that covariate i is assigned to cluster j.

Furthermore, from Equation (7), we see that w(j) defines the logistic regression weight for cluster j. Also, note that due to the regularizer of w, we have that w(j) is zero, if cluster j does not exist.

The effect of this proposed formulation is also illustrated in FIGS. 3 and 4. FIG. 3 gives an example of the matrix Z used by the present invention. FIG. 4 gives an example of the clustering result acquired by the present invention. As shown FIG. 4, the final result consists of three clusters (“fantastic”, “great”), (“bad”), and (“actor”).

### Larger Weights for Larger Clusters

In order to be able to determine λ using cross-validation, it is necessary that the forming of clusters helps to increase generalizability. One way to encourage the forming of clusters is to punish weights of smaller clusters more than the weights of larger clusters. One possibility is the following extension:

$$\begin{matrix}minimize - {\sum }_{s = 1}^{n} log f ( {y}_{s} \vert {x}_{s} , β , {β}_{0} ) + λ {\sum }_{j = 1}^{d} {‖ Z {.}_{, j} ‖}_{2} + γ {\sum }_{j} \frac{{w}_{j}^{2}}{{ρ}_{j}} & [ Math .10 ] \\ subject to β = Zw , & [ Math .11 ] \\ ∀ i , j ∈ \{ 1 , … , d \} \text{:} {Z}_{ij} \geq 0 , & [ Math .12 ] \\ ∀ i ∈ \{ 1 , … , d \} \text{:} {\sum }_{j} {Z}_{ij} = 1 & [ Math .13 ] \\ ∀ j ∈ \{ 1 , … , d \} \text{:} {ρ}_{j} = 1 + {\sum }_{i} {Z}_{ij} . & [ Math .14 ]\end{matrix}$$

pⱼ corresponds to the expected number of covariates in cluster j plus one (which is added to prevent division by zero in the objective function). The term B (Math. 15) penalizes high cluster weights in order to prevent over-fitting, whereas small clusters are penalized more. Note that C(Math. 16) is convex, since it is the sum of d functions of the form f(wⱼ, pⱼ)=wⱼ²/pⱼ, where f(wⱼ, pⱼ) is convex (see e.g. reference [2] page 72)

Reference [2]: Stephen Boyd and Lieven Vandenberghe. Convex optimization. Cambridge university press, 2004.

$$\begin{matrix}B = γ {\sum }_{j} \frac{{w}_{j}^{2}}{{p}_{j}} & [ Math .15 ] \\ C = {\sum }_{j} \frac{{w}_{j}^{2}}{{p}_{j}} & [ Math .16 ]\end{matrix}$$

### Including Auxiliary Information of Covariates

Let S be a similarity matrix between any two covariates i₁ and i₂. For example, for text classification, each corresponds to a word. In that case, we can acquire a similarity matrix between words using word embeddings. Let eᵢ εR^{h} denote the embedding of the i-th covariate. Then, we can define S as follows:

$${c}_{s} ( j ) = \{ \begin{matrix}0 , & if cluster j does not exist , \\ {\sum }_{i} {x}_{s} ( i ) {Z}_{i , j} , & if cluster j exists .\end{matrix} \qquad [ Math . 9 ]$$

where u is a hyper-parameter.

In incorporate the prior knowledge given by S, we propose to add the following penalty:

$$υ {\sum }_{{i}_{1} < {i}_{2}} {S}_{{i}_{1} {i}_{2}} {‖ {Z}_{{i}_{{1}^{′}}} - {Z}_{{i}_{{2}^{′}}} ‖}_{q} . \qquad [ Math .18 ]$$

where q ε{1, 2, ∞}. The penalty encourages similar covariates to share the same cluster assignment.

The final optimization problem is then

$$\begin{matrix}minimize - {\sum }_{s = 1}^{n} log f ( {y}_{s} \vert {x}_{s} , β , {β}_{0} ) + λ {\sum }_{i = 1}^{d} {‖ Z {.}_{j} ‖}_{2} + γ {\sum }_{i = 1}^{d} \frac{{w}_{j}^{2}}{{ρ}_{j}} + υ {\sum }_{{i}_{1} < {i}_{2}} {S}_{{i}_{1} {i}_{2}} {‖ {Z}_{{i}_{{1}^{′}}} - {Z}_{{i}_{{2}^{′}}} ‖}_{q} & [ Math .19 ] \\ subject to β = Zw & [ Math .20 ] \\ ∀ i , j ∈ \{ 1 , … , d \} \text{:} {Z}_{ij} \geq 0 , & [ Math .21 ] \\ ∀ i ∈ \{ 1 , … , d \} \text{:} { \sum }_{j = 1}^{d} {Z}_{ij} = 1 & [ Math .22 ] \\ ∀ j ∈ \{ 1 , … , d \} \text{:} {ρ}_{j} = 1 + {\sum }_{i = 1}^{d} {Z}_{ij} . & [ Math .23 ]\end{matrix}$$

### Optimization

As pointed out before, the final optimization problem in Equation (19) is not convex. However, we can get a stationary point by alternating between the optimization of w (holding Z fixed) and Z (holding w fixed). Each step is a convex problem, and can, for example, solved by the Alternating Direction Method of Multipliers. The quality of the stationary point depends on the initialization. One possibility is to initialize Z with the clustering result from k-means.

### Formulation 2: A Convex Formulation

In the formulation 2, the loss function has a weight for each cluster, and the additional penalty, the additional penalty penalizes large weights, and is less for larger clusters.

Let BεR^{kxd}, where k is the number of classes, and d is the number of covariates. B [symbol] is the weight vector for class 1. Furthermore, β₀εR^{k} contains the intercepts. We now assume the multi-class logistic regression classifier defined by the following equation.

$$f ( y \vert x , B , {β}_{0} ) = \frac{exp ( {B}_{y} , x + {β}_{0} ( y ) )}{{\sum }_{{y}^{′}} exp ( {B}_{{y}^{′} ,} x + {β}_{0} ( {y}^{′} ) )} . \qquad [ Math .24 ]$$

We propose the following formulation for jointly classifying samples x, and clustering the covariates:

$${minimize}_{B , {β}_{0}} - {\sum }_{s = 1}^{n} log f ( {y}_{s} \vert {x}_{s} , B , {β}_{0} ) + υ {\sum }_{{i}_{1} < {i}_{2}} {S}_{{i}_{1} {i}_{2}} {‖ B {.}_{, {i}_{1}} - B {.}_{, {i}_{2}} ‖}_{2} . \qquad [ Math .25 ]$$

The last term is a group lasso penalty on the alas weights for any pair of two features i₁ and i₂. The penalty is large for similar features, and therefore encourages that B [symbol] -B [symbol] is 0, that means that B [symbol] and B [symbol] are equal.

The final clustering of the features can be found by grouping two features i₁ and i₂ together if B [symbol] and B [symbol] are equal.

The advantage of this formulation is that the problem is convex, and we are therefore guaranteed to find a global minima.

Note that this penalty shares some similar to convex clustering as in references [3] and [4]. However, one major difference is that we do not introduce latent vectors for each data point, and our method can jointly learn the classifier and the clustering.

Reference [3]: Eric C Chi and Kenneth Lange. Splitting methods for convex clustering.

Journal of Computational and Graphical Statistics, 24(4): 994{1013, 2015.

Reference [4]: Toby Dylan Hocking, Armand Joulin, Francis Bach, and Jean-Philippe Vert. Clusterpath an algorithm for clustering using convex fusion penalties. In 28th international conference on machine learning, page 1, 2011.

### Extensions

### Combination With Different Penalties

In order to enable feature selection, we can combine our method with another appropriate penalty. In general, we can add an additional penalty term g(B) which is controlled by the hyper-parameter γ:

$${minimize}_{B , {β}_{0}} - {\sum }_{s = 1}^{n} log f ( {y}_{s} \vert {x}_{s} , B , {β}_{0} ) + υ {\sum }_{{i}_{1} < {i}_{2}} {S}_{{i}_{1} {i}_{2}} {‖ B {.}_{, {i}_{1}} - B {.}_{, {i}_{2}} ‖}_{2} + γ g ( B ) . \qquad [ Math .26 ]$$

For example, by placing an 12 group lasso penalty on the columns of B, we can achieve the selection of features. This means we set g as follows.

$$g ( B ) = {\sum }_{l} {‖ B {.}_{, l} ‖}_{2} . \qquad [ Math .27 ]$$

In more detail, this achieves that features that are irrelevant for the classification task are filtered out (i.e. the corresponding column in B is set to 0).

Another example is to place an additional 11 or 12 penalty on the entries of B, which can prevent over-fitting of the classifier. This means we set g follows.

$$g ( B ) = {\sum }_{i , j} {\vert {B}_{i , j} \vert}^{q} , \qquad [ Math .28 ]$$

The exponent is qε{1,2]. For example, consider the situation where feature i₁ and i₂ both occur only in training samples of class 1, and for simplicity that ∀ⱼ≠i₁:S_{j,i1}=S_{i1,j}=0and ∀ⱼ≠i₂:S_{j,i2}=S_{i2,j}=0 and S_{i1,i2}=1. Then, without any additional penalty on the entries of B, the trained classifier will place an infinite weight on class 1 for these two features (i.e., B [symbol] =∞, and B [symbol] =∞).

### Operations of Apparatus

Next, operations performed by the regression apparatus 10 according to an embodiment of the present invention will be described with reference to FIG. 5. FIG. 5 is a flow diagram showing an example of operations performed by a regression apparatus according to an embodiment of the present invention. FIGS. 1 to 4 will be referred to as needed in the following description. Also, in the present embodiment, the regression method is carried out by allowing the regression apparatus 10 to operate. Accordingly, the description of the regression method of the present embodiment will be substituted with the following description of operations performed by the regression apparatus 10.

First, as shown in FIG. 1, the train classifier unit 11 train a classifier with a weight vector or a weight matrix, using labeled training data, a similarity of features, a loss function characterizing regression quality, and a penalty encouraging the similarity of features (step S1).

Next, the acquire clustering result unit 12, using the named classifier, identifies feature clusters by grouping the features which regression weight is equal (step S2). Next, the acquire clustering result unit outputs the feature clusters identified (step S3).

### Ordinary Regression

We note that it is straight forward to apply our idea to ordinary regression. Let yεR denote the response variable. In order to jointly learn the regression parameter vector PEW and the clustering, we can use the following convex optimization problem:

$${minimize}_{β} {\sum }_{s = 1}^{n} {‖ {y}_{s} - {x}_{s}^{T} β ‖}_{2}^{2} + υ {\sum }_{{i}_{1} < {i}_{2}} {S}_{{i}_{1} {i}_{2}} {‖ {β}_{{i}_{1}} - {β}_{{i}_{2}} ‖}_{2} . \qquad [ Math .29 ]$$

### Interpretable Classification Result

The classifier that was trained using Equation (19) or Equation (25) can then be used for classification of a new data sample x*. Note that an ordinary logistic regression classifier will use each feature separately, and therefore it is difficult to identify features that are important. For example, in text classification there can be thousands of features (words), whereas an appropriate clustering of the words, reduces the feature space by a third or more. Therefore, inspecting and interpreting the clustered feature space can be much easier.

### Program

A program of the present embodiment need only be as program for causing a computer to execute steps A1 to A3 shown in FIG. 5. The regression apparatus 10 and the regression method according to the present embodiment can be realized by installing he program on a computer and executing it. In this case, the Processor of the computer functions as the train classifier unit 11 and the acquire clustering result unit 12, and performs processing.

The program according to the present exemplary embodiment may be executed by a computer system constructed using a plurality of computers. In this case, for example, each computer may function as a different one of the train classifier unit 11 and the acquire clustering result unit 12.

Also, a computer that realizes the regression apparatus 10 by executing the program according to the present embodiment will be described with reference to the drawings. FIG. 6 is a block diagram showing an example of a computer that realizes the monitoring apparatus according to an embodiment of the present invention.

As shown in FIG. 6, the computer 110 includes a CPU 111, a main memory 112, a storage device 113, an input interface 114, a display controller 115, a data reader/writer 116, and a communication interface 117. These units are connected via a bus 121 so as to be capable of mutual data communication.

The CPU 111 carries out various calculations by expanding programs (codes) according to the present embodiment, which are stored in the storage device 113, to the main memory 112 and executing them in a predetermined sequence. The main memory 112 is typically a volatile storage device such as a DRAM (Dynamic Random Access Memory). Also, the program according to the present embodiment is provided in a state of being stored in a computer-readable storage medium 120. Note that the program according to the present embodiment may be distributed over the Internet, which is connected to via the communication interface 117.

Also, specific examples of the storage device 113 include a semiconductor storage device such as a flash memory, in addition to a hard disk drive. The input interface 114 mediates data transmission between the CPU 111 and an input device 118 such as a keyboard or a mouse. The display controller 115 is connected to a display device 119 and controls display on the display device 119.

The data reader/writer 116 mediates data transmission between the CPU 111 and the storage medium 120, reads out programs from the storage medium 120, and writes results of processing performed by the computer 110 in the storage medium 120. The communication interface 117 mediates data transmission between the CPU 111 and another computer.

Also, specific examples of the storage medium 120 include a general-purpose semi-conductor storage device such as CF (Compact Flash (registered trademark)) and SD (Secure Digital), a magnetic storage medium such as a flexible disk, and an optical storage medium such as a CD-ROM (Compact Disk Read Only Memory).

The regression apparatus 10 according to the present exemplary embodiment can also be realized using items of hardware corresponding to various components, rather than using the computer having the program installed therein. Furthermore, a part of the regression apparatus 10 may be realized by the program, and the remaining part of the regression apparatus 10 may be realized by hardware.

The above-described embodiment can be partially or entirely expressed by, but is not limited to, the following Supplementary Notes 1 to 9.

### Supplementary Note 1

A regression apparatus for optimizing a joint regression and clustering criteria, the regression apparatus comprising:

a train classifier unit that trains a classifier with a weight vector or a weight matrix, using labeled training data, a similarity of features, a loss function characterizing regression quality, and a penalty encouraging the similarity of features, wherein the strength of the penalty is proportional to the similarity of features,

an acquire clustering result unit that, uses the trained classifier, to identify feature clusters by grouping the features which regression weights are equal.

### Supplementary Note 2

The regression apparatus according to Supplementary Note 1,

Wherein the loss function is the multi-logistic regression loss with regression weight vector for each and including a penalty,

the penalty is set for each pair of features, and consists o some distance measure between each pair of feature weights times the similarity between the features.

### Supplementary Note 3

The regression apparatus according to Supplementary Note 1,

Wherein the loss function has a weight for each cluster, and an additional penalty, the additional penalty penalizes large weights, and is less for larger clusters.

### Supplementary Note 4

A regression method for optimizing a joint regression and clustering criteria, the regression method comprising:

(a) a step of training a classifier with a weight vector or a weight matrix, using labeled training data, a similarity of features, a loss function characterizing regression quality, and a penalty encouraging the similarity of features, wherein the strength of the penalty is proportional to the similarity of features,

(b) a step of, by using the trained classifier, identifying feature clusters by grouping the features which regression weights are equal.

### Supplementary Note 5

The regression method according to Supplementary Note 4,

Wherein the loss function is the multi-logistic regression loss with regression weight vector for each feature, and including a penalty,

the penalty is set for each pair of features, and consists of some distance measure between each pair of feature weights times the similarity between the features.

### Supplementary Note 6

The regression method according to Supplementary Note 4,

Wherein the loss function has a weight for each cluster, and an additional penalty, the additional penalty penalizes large weights, and is less for larger clusters,

### Supplementary Note 7

A computer-readable recording medium having recorded therein a program for optimizing a joint regression and clustering criteria using a computer, the program including an instruction to cause the computer to execute;

(a) a step of training a classifier with a weight vector or a weight matrix, using labeled training data, a similarity of features, a loss function characterizing regression quality, and a penalty encouraging the similarity of features, wherein the strength of the penalty is proportional to the similarity of features,

(b) a step of, by using the trained classifier, identifying feature clusters by grouping the features which regression weights are equal,

### Supplementary Note 8

The computer-readable recording medium according to Supplementary Note 7,

Wherein the loss function is the multi-logistic regression loss with regression weight vector for each feature, and including a penalty,

the penalty is set for each pair of features, and consists of some distance measure between each pair of feature weights times the similarity between the features.

### Supplementary Note 9

The computer-readable recording medium according to Supplementary Note 7,

Wherein the loss function has a weight for each cluster, and an additional penalty, the additional penalty penalizes large weights, and is less for larger clusters.

### INDUSTRIAL APPLICABILITY

Risk classification is an ubiquitous problem ranging from detecting cyberattacks to diseases and suspicious emails. Past incidents, resulting in labeled data, can be used to train a classifier and allow (early) future risk detection. However, in order to acquire new insights and easy interpretable results, it is crucial to analyze which combination of factors (covariates) are indicative of the risks. By jointly clustering the covariates (e.g. words in a text classification task), the resulting classifier is easier to interpret and can help the human expert to formulate hypotheses about the types of risks (clusters of the covariates).

### REFERENCE SIGNS LIST

10 Regression apparatus
11 Train classifier unit
12 Acquire clustering result unit
110 Computer
111 CPU
112 Main memory
113 Storage device
114 Input interface
115 Display controller
116 Data reader/writer
117 Communication interface
118 Input device
119 Display apparatus
120 Storage medium
121 Bus

1. A regression apparatus for optimizing a joint regression and clustering criteria, the regression apparatus comprising:
a train classifier unit that trains a classifier with a weight vector or a weight matrix, using labeled training data, a similarity of features, a loss function characterizing regression quality, and a penalty encouraging the similarity of features, wherein the strength of the penalty is proportional to the similarity of features,
an acquire clustering result unit that, uses the trained classifier, to identify feature clusters by grouping the features which regression weights are equal.

2. The regression apparatus according to claim 1,
Wherein the loss function is the multi-logistic regression loss with regression weight vector for each feature, and including a penalty,
the penalty is set for each pair of features, and consists of some distance measure between each pair of feature weights times the similarity between the features.

3. The regression apparatus according to claim 1,
Wherein the loss function has a weight for each cluster, and an additional penalty,
the additional penalty penalizes large weights, and is less for larger clusters.

4. A regression method for optimizing a joint regression and clustering criteria, the regression method comprising:
(a) training a classifier with a weight vector or a weight matrix, using labeled training data, a similarity of features, a loss function characterizing regression quality, and a penalty encouraging the similarity of features, wherein the strength of the penalty is proportional to the similarity of features,
(b) by using the trained classifier, identifying feature clusters by grouping the features which regression weights are equal.

5. The regression method according to claim 4,
Wherein the loss function is the multi-logistic regression loss with regression weight vector for each feature, and including a penalty,
the penalty is set for each pair of features, and consists of some distance measure between each pair of feature weights times the similarity between the features.

6. The regression method according to claim 4,
Wherein the loss function has a weight for each cluster, and an additional penalty,
the additional penalty penalizes large weights, and is less for larger clusters.

7. A non-transitory computer-readable recording medium having recorded therein a program for optimizing a joint regression and clustering criteria using a computer, the program including an instruction to cause the computer to execute:
(a) a step of training a classifier with a weight vector or a weight matrix, using labeled training data, a similarity of features, a loss function characterizing regression quality, and a penalty encouraging the similarity of features, wherein the strength of the penalty is proportional to the similarity of features,
(b) a step of, by using the trained classifier, identifying feature clusters by grouping the features which regression weights are equal.

8. The non-transitory computer-readable recording medium according to claim 7,
Wherein the loss function is the multi-logistic regression loss with regression weight vector for each feature, and including a penalty,
the penalty is set for each pair of features, and consists of some distance measure between each pair of feature weights times the similarity between the features.

9. The non-transitory computer-readable recording medium according to claim 7,
Wherein the loss function has a weight for each cluster, and an additional penalty,
the additional penalty penalizes large weights, and is less for larger clusters.
